(19) United States
(12) Patent Application Publication
(10) Pub. No.: US 2005/0037114 A1
(43) Pub. Date: Feb. 17, 2005

(54) Case-ready food packaging system

(76) Inventors: Marshall Weems, Darien, GA (US); Richard Barry, South Dartmouth, MA (US)

Correspondence Address: SUTHERLAND ASBILL & BRENNAN LLP, 999 PEACHTREE STREET, N.E., ATLANTA, GA, 30309, US

(21) Appl. No.: 10/897,561

(22) Filed: Jul. 23, 2004

Related U.S. Application Data
(60) Provisional application No. 60/490,311, filed on Jul. 25, 2003.

(51) Int. Cl. A23B 4/00

(52) U.S. Cl. 426/115

(57) ABSTRACT

The invention relates to a method and product for packaging perishable food. The method comprises washing the perishable food with ozonated water and thereafter storing the perishable food in a case-ready package. The case-ready package comprises a tray, a liquid absorbent pad disposed in the tray for absorbing liquid, a food grade carbon dioxide generator disposed in the tray, and a cover for sealing the liquid absorbent pad, the food grade carbon dioxide generator, and the perishable food in the tray. The liquid absorbent pad absorbs liquid carried by or discharged from the perishable food and the food grade carbon dioxide generator persistently emits carbon dioxide in the package thereby retarding the growth of bacteria in the package and the spoilage of food, extending the shelf life of the package of perishable food.

### CROSS-REFERENCE OF PRIOR APPLICATION

The present invention claims priority under 35 U.S.C. §119 to U.S. provisional patent application Ser. No. 60/490,311 filed Jul. 25, 2003.

### BACKGROUND OF THE INVENTION

Perishable foods such as meats, seafood, fruits, vegetables, and the like, are often delivered to retail grocery establishments in case-ready retail packaging or are packaged on-site at the retail location in case-ready retail packaging. Case-ready retail packaging is ready for display in a retail display case.

The shelf life of case-ready retail packaged perishable foods varies, but generally, is relatively short and is critical to the profitability of the retail establishment. Thus, it is desirable to extend the shelf life of case-ready retail packaged perishable food.

### SUMMARY OF THE INVENTION

It is desirable to extend the relatively short shelf life of case-ready retail packaged perishable foods to retain food quality and profitability. The case-ready food packaging system of this invention encompasses a method for packaging perishable food in a case-ready package and a case-ready package for use in such a method.

Generally, the method of this invention for packaging perishable food in a case-ready package comprises washing the perishable food with ozonated water and thereafter storing the perishable food in a case-ready package comprising a tray, a liquid absorbent pad disposed in the tray for absorbing liquid, a food grade carbon dioxide generator disposed in the tray, and a cover for sealing the liquid absorbent pad, the food grade carbon dioxide generator, and the perishable food in the tray. The liquid absorbent pad absorbs liquid carried by or discharged from the perishable food and the food grade carbon dioxide generator persistently emits carbon dioxide in the package and thereby retards growth of bacteria in the package and spoilage of the food. Thus, the carbon dioxide in the case-ready package extends the shelf life of the package.

### BRIEF DESCRIPTION OF THE DRAWINGS

FIG. 1 is a perspective view of a case ready food packaging system made in accordance with an embodiment of this invention.

FIG. 2 is an elevation view of the case ready food packaging system illustrated in FIG. 1.

FIG. 3 graphically illustrates results of seafood shelf life tests for cooked test samples treated with the ozonation and carbon dioxide food packaging system in accordance with embodiments of this invention.

FIG. 4 graphically illustrates results of seafood shelf life tests for raw test samples treated with the ozonation and carbon dioxide food packaging system in accordance with embodiments of this invention.

FIG. 5 graphically illustrates results of seafood shelf life tests for raw control samples not treated with the ozonation and carbon dioxide food packaging system with embodiments of this invention.

FIG. 6 graphically illustrates results of seafood shelf life tests for cooked control samples not treated with the ozonation and carbon dioxide food packaging system with embodiments of this invention.

FIG. 7 graphically illustrates results of bacteria counts for raw control samples vs raw treated samples with embodiments of this invention.

### DETAILED DESCRIPTION

The present invention provides a method and case-ready package for extending the shelf life of perishable food. The method comprises washing the perishable food with ozonated water and storing the food in the case-ready package. The method and case-ready package are suitable for use with perishable foods such as meats, seafood, fruits, vegetables, and the like.

The initial step of washing the perishable food with ozonated water kills bacteria on the food. The ozonated water is produced by an ozonation system which is known to those skilled in the art. The level of ozonation in the water is suitably from 1 ppm to 3 ppm (parts per million) and desirably 3 ppm. The washed perishable food is thereafter stored in a package as described below.

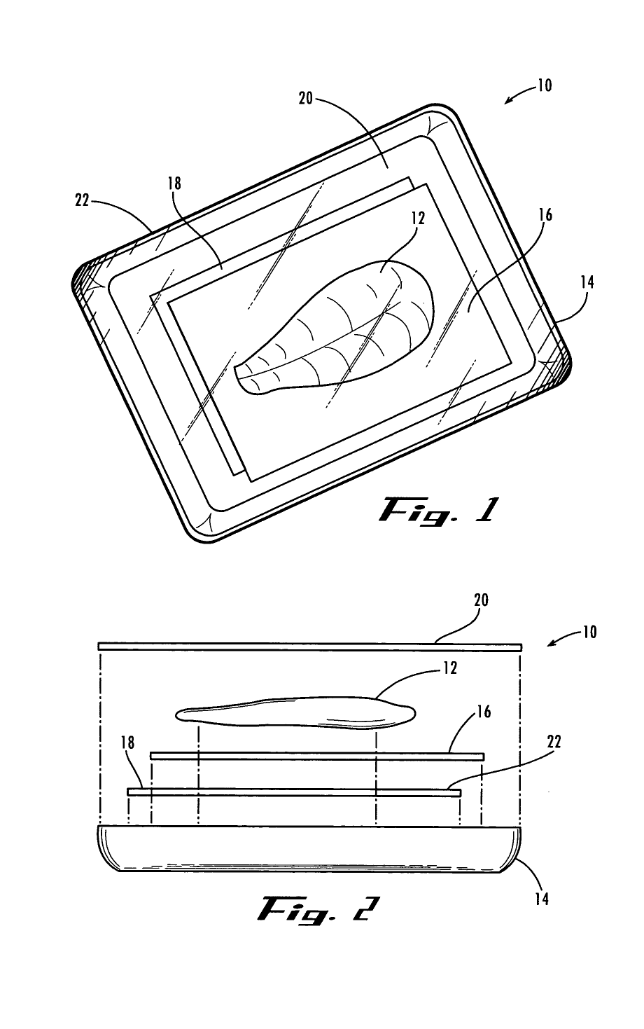

A package 10 made according to an embodiment of this invention for storing a perishable food item such as a fish filet 12 is illustrated in FIGS. 1 and 2 and comprises a tray 14, a liquid absorbent pad 16 disposed in the tray for absorbing liquid, a food grade carbon dioxide generator 18 disposed in the tray between the liquid absorbing pad and the tray, and a cover 20 for sealing the liquid absorbent pad, the food grade carbon dioxide generator, and the perishable food in the tray.

The tray 14 holds liquid that is carried by the perishable food or discharged by the perishable food during storage in the case-ready package. The tray can be made of a variety of materials including paper, metal, glass, or plastic, but desirably is made of reusable and recyclable plastic. More desirably, the tray 14 is heat resistant and top rack dishwasher safe. A top rack dishwasher safe, recyclable and reusable polypropylene tray is preferred.

The liquid absorbent pad 16 disposed in the tray absorbs liquid carried by or discharged from the perishable food. Suitable liquid absorbent pads 16 for perishable food packaging are well known and desirably comprise absorbent fluff pulp disposed between layers of polymer film, at least one of which is perforated. A desirable liquid absorbent pad is available from Cryovac Sealed Air Corporation under the name DRI-LOC.

The food grade carbon dioxide generator 18 persistently emits carbon dioxide inside the case-ready packaging and slows the growth of bacteria in the package, thereby slowing spoilage of the perishable food and extending the shelf life of the perishable food. A suitable food grade carbon dioxide generator 18 is a carbon dioxide generating packet comprising carbon dioxide generating pellets disposed in a breathable non-woven fabric pouch. A desirable food grade carbon dioxide generating packet is available from CO₂ Technologies under the name CO₂ PAK. The carbon dioxide generating pellets are desirably non-sublimating. An example of a sublimating carbon dioxide generator is dry ice. The food grade carbon dioxide generating packet 18 is substantially flat and can be disposed anywhere in the case-ready package, but is desirably disposed beneath or on top of the liquid absorbent pad 16 and between the tray 14 and the perishable food disposed in the package. In such an arrangement, the liquid absorbent pad 16 and the carbon dioxide generating packet 18 are not visible or are substantially obscured from sight by the perishable food 12 in the package 10.

The CO2 is moisture activated and will produce an alkaline pH on the surface of the fish fillets exposed inside the tray. An alkaline environment has been shown in other studies to retard the growth of bacteria associated with product degradation. The CO2 gas emitted by the carbon dioxide generator 18 is permitted to escape the tray environment over a short period of time through the gas permeable film. This contradicts the definition of a MAP (modified atmosphere package); MAP are flushed with inert gases, e.g. Nitrogen, which make the internal tray environment anaerobic. The MAP system is a health hazard as botulism may form. In contrast, the system of this invention allows for the exchange of atmospheric gases. The absorbent pad 16 also enhances the shelf-life of the packaged food. For example, fish degradation is dramatically enhanced if the fish remains submerged in fish weepage (fish juice) after thawing. The “fish juice” provides an perfect medium for the ubiquitous bacteria to exponentially grow.

The cover 20 sealing the case-ready package 10 can be selected from a variety of materials including, paper, foil, plastic film, and the like. The cover 20 can be wrapped around the tray 14 covering the contents of the tray or it can be adhered to the tray with adhesive or by heat sealing around the periphery 22 of the tray. According to a preferred embodiment, however, the cover 20 is a translucent or transparent polymer film so that the perishable food 12 in the case-ready package 10 is viewable through the cover. According to a particular embodiment, the cover 20 is a polymer film that is heat sealable to the tray and is gas permeable, antifogging, and translucent or transparent. Such a film is available from Dupont.

The case-ready perishable food packaging system of this invention is capable of extending shelf life of perishable food by a considerable time, such as three to twelve days. Examples illustrating embodiments of this invention were tested and compared to control samples as explained in the examples below. These examples are exemplary of particular embodiments of this invention and are not meant to limit the scope of the invention.

### Example 1

Test Samples of frozen tray packed flounder fillets were received from Biomarine Laboratories in Gloucester, Mass.

The Test Samples were packaged in accordance with an embodiment of this invention. The Test Sample flounder fillets were washed with ozonated water produced by Boston SeaFarms, Inc. in New Bedford Massachusetts. The ozonated fillets were then placed in a Rocktenn Polypropylene No. 3 Tray on top of a PS 150 Dri-Loc absorbent pad available from Cryovac Sealed Air Corporation, and CO2PAK food grade carbon dioxide generating packet available from CO2 Technologies. CO2 impregnated strips were reduced by 1/30^{th} after receiving them from the manufacturer. A gas permeable, antifogging translucent film available from Dupont was then heat-sealed to the tray to form a cover over the tray contents.

The Control Samples were packaged in the same manner but without washing with ozonated water and without a carbon dioxide generating packet.

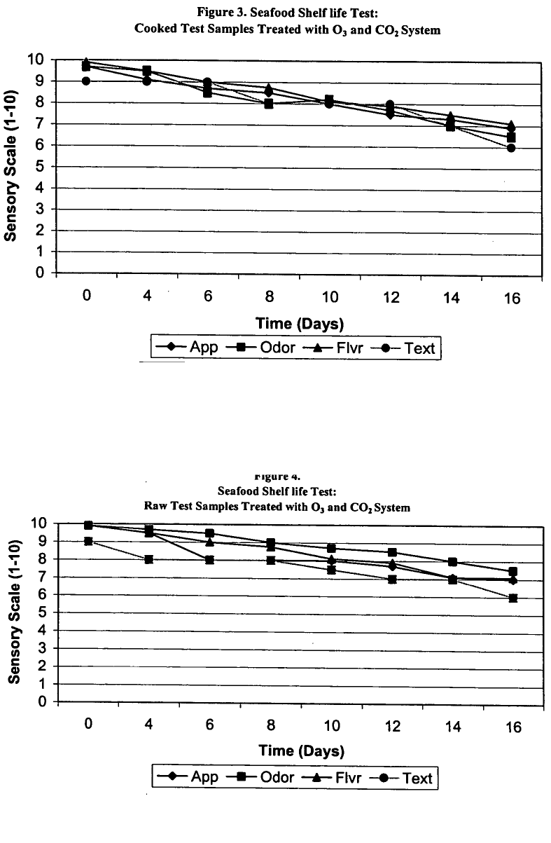

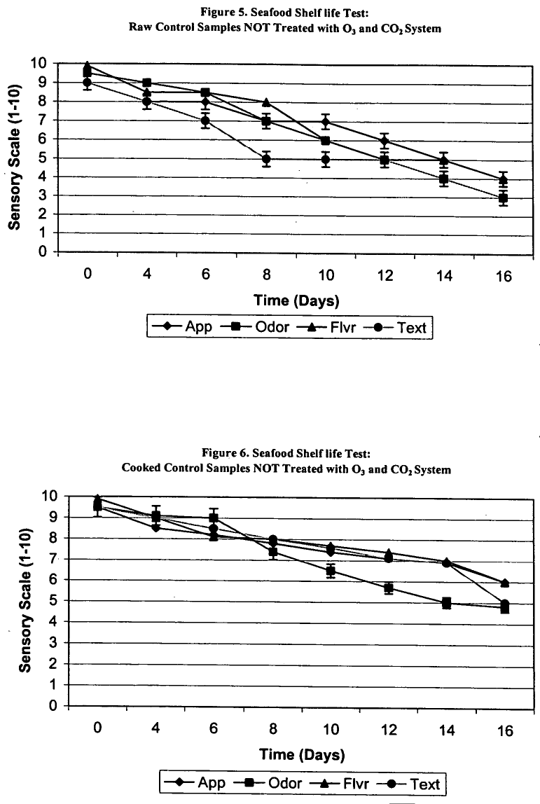

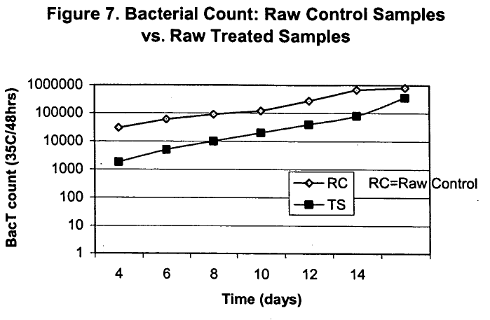

Sensory analysis was performed on the samples by the principle of Bio Marine Laboratories and Mr. Robert Learson National Marine Fisheries Laboratory, retired. The results are shown in Tables 1 and 2 below and illustrated graphically in FIGS. 3-7.

TABLE 1

| Test Samples - Raw Weighted | | | | | Test Samples - Cooked Weighted | | | | |
|---|---|---|---|---|---|---|---|---|---|
| Average | | | | | Average | | | | |
| Day | App | Odor | Flvr | Text | Day | App | Odor | Flvr | Text |
| 0 | 9.5 | 9.5 | 9.9 | 9.5 | 0 | 9.7 | 9.7 | 9.9 | 9 |
| 4 | 8.5 | 9.1 | 9 | 9 | 4 | 9.1 | 9.5 | 9.5 | 9 |
| 6 | 8.2 | 9 | 8.1 | 8.5 | 6 | 8.7 | 8.5 | 9 | 9 |
| 8 | 7.8 | 7.4 | 8 | 8 | 8 | 8.5 | 8 | 8.75 | 8 |
| 10 | 7.4 | 6.5 | 7.7 | 7.6 | 10 | 8 | 8.2 | 8.1 | 8 |
| 12 | 7.1 | 5.7 | 7.4 | 7.1 | 12 | 7.5 | 7.7 | 7.9 | 8 |
| 14 | 6.9 | 5 | 7 | 6.9 | 14 | 7.3 | 7 | 7.5 | 7 |
| 16 | 6 | 4.8 | 6 | 5 | 16 | 6.9 | 6.5 | 7.1 | 6 |
| Raw Control Samples: Weighted | | | | | Cooked Control Samples Weighted | | | | |
| Average | | | | | Average | | | | |
| Day | App | Odor | Flvr | Text | Day | App | Odor | Flvr | Text |
| 0 | 9 | 9.5 | 9.9 | 9 | 0 | 9.5 | 9.5 | 9.9 | 9.5 |
| 4 | 8 | 9 | 8.5 | 8 | 4 | 8.5 | 9.1 | 9 | 9 |
| 6 | 8 | 8.5 | 8.5 | 7 | 6 | 8.2 | 9 | 8.1 | 8.5 |
| 8 | 7 | 7 | 8 | 5 | 8 | 7.8 | 7.4 | 8 | 8 |
| 10 | 7 | 6 | 6 | 5 | 10 | 7.4 | 6.5 | 7.7 | 7.6 |
| 12 | 6 | 5 | 5 | 5 | 12 | 7.1 | 5.7 | 7.4 | 7.1 |
| 14 | 5 | 4 | 5 | 4 | 14 | 6.9 | 5 | 7 | 6.9 |
| 16 | 4 | 3 | 4 | 3 | 16 | 6 | 4.8 | 6 | 5 |

*App: Appearance ***Flvr: Flavor profile ***Text: Texture profile

TABLE 2
Average Bacterial Count for Raw Control (RC) vs. Test Samples (TS)-
Weighted Average

| Day | RC | TS |
|---|---|---|
| 4 | 30,000 | 1,800 |
| 6 | 60,000 | 5,000 |
| 8 | 90,000 | 10,000 |
| 10 | 120,000 | 20,000 |
| 12 | 275,000 | 40,000 |
| 14 | 680,000 | 80,000 |
| 16 | 800,000 | 360,000 |

The performance of the day boat flounder Control Samples was surpassed by the previously frozen treated tray pack product. Considering that the untreated Control Samples were less than 12 hours old, the Treated Samples performed extremely well.

As seen in Table 1, the Control and Test Samples performed similarly until the end of the test (Day 14-16). Sensory factors such as texture, odor, and appearance fell below satisfactory levels for the untreated samples. Variance in data was not significant (p<1) between cooked and raw treated test samples.

In general the Test Samples were excellent in terms of packaging, quality and condition and performed very well in comparison to high quality day-boat flounder.

The bacterial count tests showed that the Test Samples treated with O₃ and CO₂ had a significantly (p≧1) lower bacterial count by more than two orders of magnitude from day 0-3, 3-6, and days 6-12. It appears that the initial exposure of bacteria to ozone (O₃) was detrimental to accelerated bacterial decay in conjunction with CO₂.

By exposing the treated Test Samples to ozone-treated water during processing, product shelf life was extended significantly. Color/appearance, flavor, texture, and odor were enhanced with the treated tray-packed flounder fillets.

### Example 2

Seven samples of tilapia fillet were received from SeaFarms Group, LLC and packaged in accordance with the procedure described in Example 1. The Treated Samples were held in refrigerated storage for twenty-one (21) days. Storage temperatures were held between 32° F.-38° F. (2× cycle freeze-thaw) for the storage period. After fifteen (15) days, half the Test Samples were tested for microbiological and sensory analysis at Bio Marine laboratories in Gloucester, Mass. in accordance with the same procedure described in Example 1. The sensory analysis of the samples were completed in both the raw and cooked state and the results are shown in Table 3.

TABLE 3

| | | |
|---|---|---|
| Raw State | | |
| Appearance: | 7.0 | No Discoloration |
| Odor: | 8.0 | Good Odor-Fresh similar to flounder |
| Texture: | 8.0 | Firm not slimy-no excess moisture loss |
| Cooked State | | |
| Appearance: | 7.5 | Good Appearance-no discoloration |
| Odor: | 8.0 | No off odors |
| Texture: | 8.0 | Good flavor-typical of flounder-no indication |
| | | of rancidity |
| Over-all | 7.8 | Good quality |
| Quality: | | |

After 21 days the remaining Test Samples were examined. The sensory results are as shown in Table 4.

TABLE 4

| | | |
|---|---|---|
| Raw State | | |
| Appearance: | 6.0 | Dark Color |
| Odor: | 2.0 | Sour odor-typical of normal spoilage |
| Texture: | 4.0 | Slimy, soft |
| Cooked State | | |

Did not cook-product spoiled

There was no indication of rancidity (product did not contain enough lipids to run a T-bar(rancidity) analysis. Microbiological results conducted by Bio Marine Laboratory showed that after 14 days both total Coliforms and E.coli levels were negative. After 21 days Total Coliforms were high but the presence of E.coli was negative. The heat-sealed film used in this study did not have any effect on the fish sampled in this study. There were no microbiological, chemical, and sensory effects from the fish-film contact for samples used in this study.

As demonstrated in the examples above, which represent just one of the embodiments of the present invention, the method and package for storing perishable foods claimed below provides noticeably improved results for extending the shelf life of perishable food products.

It should be understood that the foregoing relates to particular embodiments of this invention and that numerous changes may be made therein without departing from the scope of the invention as defined by the following claims.

1. Method for packaging perishable food in a case-ready package comprising the steps of washing the perishable food with ozonated water and thereafter storing the perishable food in a case-ready package comprising:
a tray;
a liquid absorbent pad disposed in the tray for absorbing liquid;
a food grade carbon dioxide generator disposed in the tray; and
a cover for sealing the liquid absorbent pad, the food grade carbon dioxide generator, and the perishable food in the tray.

2. Method as in claim 1 wherein the level of ozonation in the ozonated water is in the range of 1 ppm to 3 ppm.

3. Method as in claim 1 wherein the level of ozonation in the ozonated water is preferably about 3 ppm.

4. Method as in claim 1 wherein the tray material is selected from the group consisting of paper, metal, glass, and plastic.

5. Method as in claim 1 wherein the tray is reusable and recyclable plastic.

6. Method as in claim 1 wherein the tray is heat resistant.

7. Method as in claim 1 wherein the tray is dishwasher safe.

8. Method as in claim 7 wherein the tray is preferably top-rack dishwasher safe reusable polypropylene.

9. Method as in claim 1 wherein the liquid absorbent pad comprises absorbent fluff pulp disposed between layers of polymer film, where at least one layer of polymer film is perforated.

10. Method as in claim 1 wherein the carbon dioxide generator comprises carbon dioxide generating pellets in a breathable non-woven fabric pouch.

11. Method as in claim 1 wherein the carbon dioxide generator is substantially flat.

12. Method as in claim 1 wherein the carbon dioxide generator is preferably placed beneath the perishable food and either on top of or beneath the liquid absorbent pad.

13. Method as in claim 1 wherein the cover material is selected from the group consisting of paper, foil, and plastic film.

14. Method as in claim 1 wherein the cover is wrapped around the tray.

15. Method as in claim 1 wherein the cover is attached to the tray with adhesive or heat-sealing.

16. Method as in claim 1 wherein the cover is gas permeable.

17. Method as in claim 1 wherein the cover is translucent or transparent polymer film.

18. Method as in claim 1 wherein the cover is preferably gas permeable, anti-fogging, translucent or transparent, and heat-sealed to the tray.

19. Method as in claim 1 wherein the liquid absorbent pad absorbs liquid carried by or discharged from the perishable food and the food grade carbon dioxide generator persistently emits carbon dioxide in the package and thereby retards growth of bacteria in the package and spoilage of the food.

20. Method as in claim 1 wherein the perishable food is selected from the group consisting of meats, seafood, fruits, and vegetables.

21. Method as in claim 1 wherein the perishable food is fish.

22. Case-ready package comprising:
a tray;
a liquid absorbent pad disposed in the tray for absorbing liquid;
a food grade carbon dioxide generator disposed in the tray; and
a cover for sealing the liquid absorbent pad, the food grade carbon dioxide generator, and the perishable food in the tray.

23. Case-ready package as in claim 1 wherein the tray material is selected from the group consisting of paper, metal, glass, and plastic.

24. Case-ready package as in claim 1 wherein the tray is reusable and recyclable plastic.

25. Case-ready package as in claim 1 wherein the tray is heat resistant.

26. Case-ready package as in claim 1 wherein the tray is dishwasher safe.

27. Case-ready package as in claim 26 wherein the tray is preferably top-rack dishwasher safe reusable polypropylene.

28. Case-ready package as in claim 1 wherein the liquid absorbent pad comprises absorbent fluff pulp disposed between layers of polymer film, where at least one layer of polymer film is perforated.

29. Case-ready package as in claim 1 wherein the carbon dioxide generator comprises carbon dioxide generating pellets in a breathable non-woven fabric pouch.

30. Case-ready package as in claim 1 wherein the carbon dioxide generator is substantially flat.

31. Case-ready package as in claim 1 wherein the carbon dioxide generator is preferably placed beneath the perishable food and either on top of or beneath the liquid absorbent pad.

32. Case-ready package as in claim 1 wherein the cover material is selected from the group consisting of paper, foil, and plastic film.

33. Case-ready package as in claim 1 wherein the cover is wrapped around the tray.

34. Case-ready package as in claim 1 wherein the cover is attached to the tray with adhesive or heat-sealing of the periphery.

35. Case-ready package as in claim 1 wherein the cover is gas permeable.

36. Case-ready package as in claim 1 wherein the cover is translucent or transparent polymer film.

37. Case-ready package as in claim 1 wherein the cover is preferably gas permeable, anti-fogging, translucent or transparent, and heat-sealed to the tray.

38. Case-ready package as in claim 1 wherein the liquid absorbent pad absorbs liquid carried by or discharged from the perishable food and the food grade carbon dioxide generator persistently emits carbon dioxide in the package and thereby retards growth of bacteria in the package and spoilage of the food.
